(19) United States
(12) Patent Application Publication
(10) Pub. No.: US 2010/0236901 A1
(43) Pub. Date: Sep. 23, 2010

(54) ENCLOSURE MEMBER AND MULTI-LINK CONVEYOR CHAIN

(76) Inventor: Christopher MARSHALL, Huddersfield (GB)

Correspondence Address: BERENATO & WHITE, LLC, 6550 ROCK SPRING DRIVE, SUITE 240, BETHESDA, MD, 20817, US

(21) Appl. No.: 12/791,424

(22) Filed: Jun. 1, 2010

Related U.S. Application Data
(62) Division of application No. 11/284,137, filed on Nov. 22, 2005.
Application No. 11/284,137 is a continuation-in-part of application No. 10/087,459, filed on Mar. 1, 2002, now abandoned.

(30) Foreign Application Priority Data
Mar. 14, 2001 (GB) 0106190.2

(51) Int. Cl. B65G 17/06

(52) U.S. Cl. 198/851

(57) ABSTRACT

A multi-link conveyor chain suitable for use in the glass industry is provided. The conveyor chain includes an enclosure member having a non-tapered counterbore for retaining and protecting a pin head of an elongate pin thereby ensuring that the integrity of the multi-link conveyor chain during use is maintained. Also provided is a method for manufacturing the multi-link conveyor chain incorporating the enclosure member.

### CROSS-REFERENCE TO RELATED APPLICATIONS

This invention is a divisional of U.S. patent application Ser. No. 11/284,137 filed Nov. 22, 2005, which is a continuation-in-part of U.S. patent application Ser. No. 10/087,459 filed on 1 Mar. 2002, the complete disclosures of which are incorporated herein by reference.

This application claims the benefit of priority of foreign patent application number 0106190.2 filed in the United Kingdom on 14 Mar. 2001, the complete disclosure of which is incorporated herein by reference.

### BACKGROUND OF THE INVENTION

1. Field of the Invention

The present invention relates to a multi-link conveyor chain which may be used (for example) in the glass industry, in particular to an enclosure member for protecting the integrity of the multi-link conveyor chain during use and to a method for manufacturing the multi-link conveyor chain incorporating the enclosure member.

2. Description of the Related Art

Multi-link conveyor chains are in widespread use in the glass industry for transporting glass products between processing stations. For example, a multi-link conveyor chain which is typically 100 feet long may be used to transport blown glass from a blowing station to an annealing station. In the conventional multi-link conveyor chain, there is a plurality of parallel spaced apart elongate pins having an oval-shaped cross-section. Mounted on adjacent elongate pins are a series of link plates spaced apart along the pin by a plurality of washers, each link plate comprising a first and a second link. Each of the first and second links is capable of engaging a drive sprocket and has an oval-shaped aperture for receiving the elongate pin. The washer is typically a circular plate with a central circular aperture for receiving the pin. The primary function of the washer is to act as a spacer which permits heat to be blown through the multi-link conveyor chain to maintain the temperature of transported hot glass articles. The multi-link conveyor chain is driven by the engagement of the links of the link plate with the multiple teeth of a drive sprocket during a cycle of engagement.

The conventional multi-link conveyor chain is assembled so that each end of the elongate pin extends beyond the outermost link plate (i.e., beyond the edge of the flat conveyor surface) and a pin head is fixed in a conventional manner to each exposed end. A disadvantage of this arrangement is that unless the guide strip adjacent to the multi-link conveyor chain is in perfect alignment with the edge of the multi-link conveyor chain, there is a tendency for the pin head to wear and eventually shear off so that the elongate pin may become dislodged. In extreme cases, this results in total collapse of the multi-link conveyor chain.

### SUMMARY OF THE INVENTION

The present invention seeks to improve multi-link conveyor chains by enclosing each end of an elongate pin in a protective enclosure member (e.g., a head protector) and by securing the elongate pin within the enclosure member by a flat pin head.

Thus viewed from one aspect the present invention provides a multi-link conveyor chain adapted to provide a substantially flat horizontal surface drivable between a first processing station and a second processing station by engagement with a drive sprocket, the multi-link conveyor chain comprising:

a plurality of elongate pins spaced apart in substantially parallel relationship including a first elongate pin adjacent to a second elongate pin, the first elongate pin having a non-circular, substantially elliptical section and a first end extending beyond a first edge of the substantially flat horizontal surface and a second end extending beyond a second edge of the substantially flat horizontal surface, the second elongate pin having a non-circular, substantially elliptical section and a first end extending beyond the first edge of the substantially flat horizontal surface and a second end extending beyond the second edge of the substantially flat horizontal surface;

a plurality of link plates mounted on adjacent elongate pins having a first link connected to a second link by a connecting portion, each of the first and second links having a main body and a circumferentially dependent sprocket engaging member, the main body defining a non-circular, substantially elliptical aperture whose shape essentially matches the non-circular, substantially elliptical section of an elongate pin;

a first enclosure member positioned at the first edge of the substantially flat horizontal surface yet being discrete and separable from the plurality of link plates and the elongate pins, comprising a first main body defining a first front face, a first rear face opposite to the first front face, and first sides opposite to one another and extending between the first front and rear faces, wherein either the first rear face has a first recess extending from one of the first sides or one of the first sides is open;

the first main body defining a first non-circular aperture and a second non-circular aperture each extending between the first front face and the first rear face, the first front face having first and second non-tapered counterbores respectively formed at the first and second non-circular apertures, wherein the shape of the first and second non-circular apertures essentially matches the non-circular, substantially elliptical sections of the first elongate pin and the second elongate pin respectively and the depth of the first and second non-circular apertures is sufficient to enclose the first end of the first elongate pin and the first end of the second elongate pin respectively;

a second enclosure member positioned at the second edge of the substantially flat horizontal surface yet being discrete and separable from the plurality of link plates and the elongate pins, comprising a second main body having a second front face, a second rear face opposite to the second front face, and second sides opposite to one another and extending between the second front and rear faces, wherein either the second rear face has a second recess extending from one of the second sides or one of the second sides is open;

the second main body defining a third non-circular aperture and a fourth non-circular aperture each extending between the second front face and the second rear face, the second front surface having third and fourth non-tapered counterbores respectively formed at the third and fourth non-circular apertures, wherein the shape of the third and fourth non-circular apertures essentially matches the non-circular, substantially elliptical sections of the first elongate pin and second elongate pin respectively and the depth of the third and fourth non-circular apertures is sufficient to enclose the second end of the first elongate pin and the second end of the second elongate pin respectively;

a first flat pin head secured to and retaining the first end of the first elongate pin and seated in the first non-tapered counterbore of the first non-circular aperture;

a second flat pin head secured to and retaining the first end of the second elongate pin and seated in the second non-tapered counterbore of the second non-circular aperture;

a third flat pin head secured to and retaining the second end of the first elongate pin and seated in the third non-tapered counterbore of the third non-circular aperture; and

a fourth flat pin head secured to and retaining the second end of the second elongate pin and seated in the fourth non-tapered counterbore of the fourth non-circular aperture.

Generally speaking, the first and second enclosure members may be identical. Each flat pin head is non-protruding. The flat pin heads may be fully encapsulated within the non-tapered counterbore. The depth of the non-tapered counterbore is typically 2 mm.

The first, second, third and fourth flat pin heads may be spin riveted (e.g., eccentrically spin riveted) flat pin heads.

By enclosing the first end and second end of each of the first and second elongate pins in the first and second enclosure members and by providing flat pin heads, the integrity of the multi-link conveyor chain is advantageously protected. In other words, the tendency for a rounded pin head exposed beyond the edge of the conveyor surface to “catch” or be sheared off is eliminated.

In a preferred embodiment, the multi-link conveyor chain comprises a plurality of first and second enclosure members as hereinbefore defined positioned respectively at the first and second edges of the substantially flat horizontal surface so as to enclose the first and second ends of each of the plurality of elongate members.

In a preferred embodiment, the main body has a substantially trapezoidal section. For example, the main body has a first side substantially parallel to a second side, wherein the second side is longer than the first side and has rounded corners. Preferably the first side has rounded corners (typically to a lesser extent than the second side). In use, the first enclosure member is positioned at the first edge with the second side uppermost. In use, the second enclosure member is positioned at the second edge with the second side uppermost. The rear face of the main body may be recessed (e.g., with a substantially U-shaped recess). The first (shorter) side may be closed or open. Where the first side is open, the main body adopts a twin flat-edged, substantially teardrop profile.

Where the shorter side is open and the rear face is non-recessed, the enclosure member is particularly useful in center guide conveyor chains. Where the shorter side is closed and the rear face is recessed, the enclosure member is particularly useful in side guide conveyor chains. Where the shorter side is closed and the rear face is non-recessed, the enclosure member is particularly useful in multi-guide conveyor chains.

Preferably the non-tapered counterbore is cylindrical. Preferably the non-tapered counterbore is a flat recess.

The enclosure member may be sized and configured so as to have a maximum radial extent which is equal to or less than adjacent link plates. This ensures that the enclosure member does not interfere with the substantially flat horizontal surface.

In a preferred embodiment, the main body of each of the first and second links of a link plate defines a non-circular aperture whose shape non-identically matches the non-circular section of the elongate pin. The non-identical match between the non-circular section of the elongate pin and the shape of the non-circular aperture defined by the main body of the link causes the link plate to be advantageously driven by the elongate pin throughout the cycle of engagement with the drive sprocket.

Preferably the multi-link conveyor comprises a plurality of elongate pins spaced apart in substantially parallel relationship including a first elongate pin adjacent to a second elongate pin which is adjacent to a third elongate pin, each of the elongate pins having a first end, a second end and a non-circular section, wherein a plurality of link plates are consecutively mounted in a staggered fashion along the first, second and third elongate pin.

In a preferred embodiment, the circumferentially dependent sprocket engaging member of each of the first and second links of the link plate is substantially flat edged. Preferably each of the first and second links of the link plate has a flat-edged, substantially teardrop profile.

Link plates may be mounted consecutively along an elongate pin. Certain (e.g., all) link plates may be spaced apart by one or more spacers. The main body of the (or each) spacer may define a circular or non-circular aperture. In a preferred embodiment of the invention, each spacer comprises a main body defining a non-circular aperture for receiving the elongate pin whose shape essentially matches the non-circular section of the elongate pin.

Preferably the non-circular section of the elongate pin is substantially elliptical (or oval). Preferably the non-circular aperture defined by the main body of the (or each) link is substantially elliptical (or oval) with an enlarged side portion. Particularly preferably the enlarged side portion extends inwardly towards the connecting portion.

It is not intended that the present invention be limited to use in the glass industry. It is expected that the multi-link conveyor chain of the invention will be suitable in any industry which desires transportation between a first station and a second station. For example, the multi-link conveyor chain of the invention could be used to transport automotive parts in the automotive industry.

Viewed from a further aspect the present invention provides a first or second enclosure member as hereinbefore defined.

The enclosure member may be fitted to any type of multi-link conveyor chain, in particular those available from Pennine Industrial Equipment Limited (Huddersfield, England) such as their PREMIUM range. It may be fitted to multi-link conveyor chains of 2 inch or 1 inch pitch being link only or link/spacer assemblies of center guide, side-guide or multi-guide type. In each case, it is preferred to fit first and second enclosure members at each end of an adjacent pair of elongate pins.

The manufacture of such a multi-link conveyor chain enclosing both ends of an elongate pin in respective enclosure members leads to particular difficulties which may be overcome in accordance with the method of the present invention.

Viewed from a yet further aspect the present invention provides a method for manufacturing a multi-link conveyor chain as hereinbefore defined comprising:

(A) spin riveting the first flat pin head to the first end of the first elongate pin;

(B) inserting the second end of the first elongate pin into the first non-circular aperture defined by the main body of the first enclosure member;

(C) inserting the second end of the first elongate pin into the non-circular aperture defined by the first or second link of the link plates to a position where the first flat pin head is seated in the first non-tapered counterbore of the first enclosure member;

(D) inserting the second end of the first elongate pin into the third non-circular aperture of the second enclosure member to a position where the second end is adjacent the third non-tapered counterbore within the third non-circular aperture;

(E) eccentrically spin riveting the second end of the first elongate pin to produce the third flat pin head seated in the third non-tapered counterbore of the second enclosure member;

(F) spin riveting the second flat pin head to the first end of the second elongate pin;

(G) inserting the second end of the second elongate pin into the second non-circular aperture defined by the main body of the first enclosure member;

(H) inserting the second end of the second elongate pin into the non-circular aperture defined by the first or second link of the link plates to a position where the second flat pin head is seated in a second non-tapered counterbore of the first enclosure member;

(I) inserting the second end of the second elongate pin into the fourth non-circular aperture of the second enclosure member to a position where the second end is in the fourth non-tapered counterbore; and

(J) eccentrically spin riveting the second end of the second elongate pin to produce a fourth flat pin head seated in the fourth non-tapered counterbore.

Whilst it is relatively straightforward to enclose the first end of an elongate pin in the first enclosure member and thereafter to secure a second pin head to a free second end of the elongate pin, it is less straightforward to secure a second pin head to the second end of the elongate pin when the second end is fitted with a second enclosure member. This is due to the space constraints imposed on the second pin head by the non-circular aperture in the second enclosure member. These space constraints are overcome in accordance with the method of the invention.

Materials suitable for spin riveting are familiar to those skilled in the art (e.g., carbide). Steps (A) and (G) may be carried out by eccentric spin riveting.

Typically the desired diameter of the flat pin head is the length of the major axis. By way of example, where the desired diameter is between 6.0 and 6.3 mm and the counterbore is of 6.5 mm diameter, a piece of carbide of diameter 6.3 mm is spin riveted at an eccentricity of about 0.05 mm to produce a flat pin head seated in the non-tapered counterbore.

### BRIEF DESCRIPTION OF THE DRAWINGS

The accompanying drawings which are incorporated in and constitute part of the specification illustrate presently preferred embodiments and methods of the invention and together with the general description given above and the detailed description given below serve to explain the principles of the invention.

FIG. 1 illustrates a first embodiment of the enclosure member of the invention;

FIG. 2a illustrates an embodiment of the multi-link conveyor assembly of the invention;

FIG. 2b illustrates in isolation a partial side view of the multi-link conveyor of FIG. 2a;

FIGS. 3a and 3b illustrate a second embodiment of the enclosure member of the invention; and

FIG. 4 illustrates a third embodiment of the enclosure member of the invention.

### DETAILED DESCRIPTION OF THE PREFERRED EMBODIMENTS AND PREFERRED METHODS OF THE INVENTION

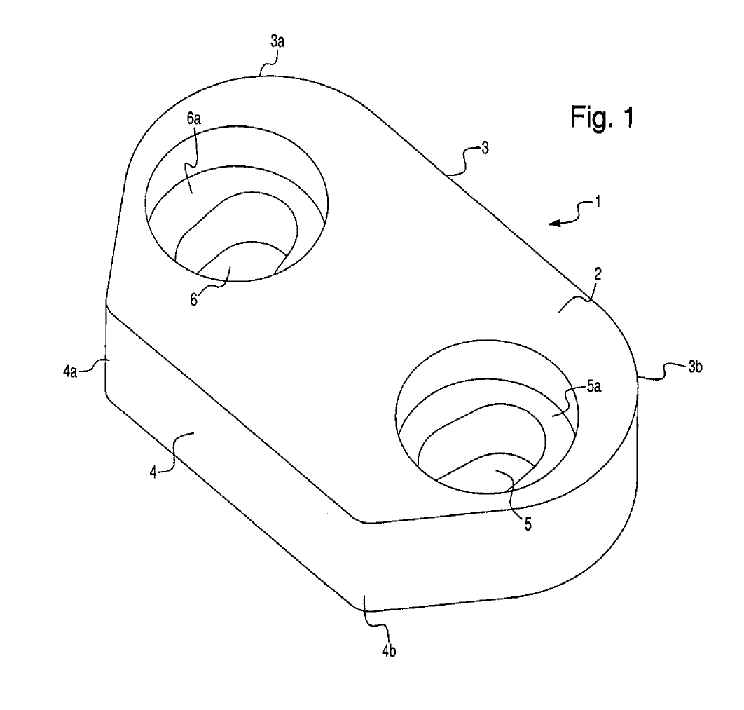

FIG. 1 illustrates a first embodiment of the enclosure member of the invention designated generally by reference numeral 1. The enclosure member 1 includes a trapezoidal main body 2 having a long side 3 parallel to a closed short side 4. The corners 3a and 3b of the long side 3 are rounded off (and to a lesser extent so are the corners 4a and 4b of the short side 4). The main body 2 defines a first non-circular aperture 5 and a second non-circular aperture 6, each of which are elliptical and provided with a cylindrical counterbore 5a and 6a respectively. The counterbores 5a and 6a are non-tapered.

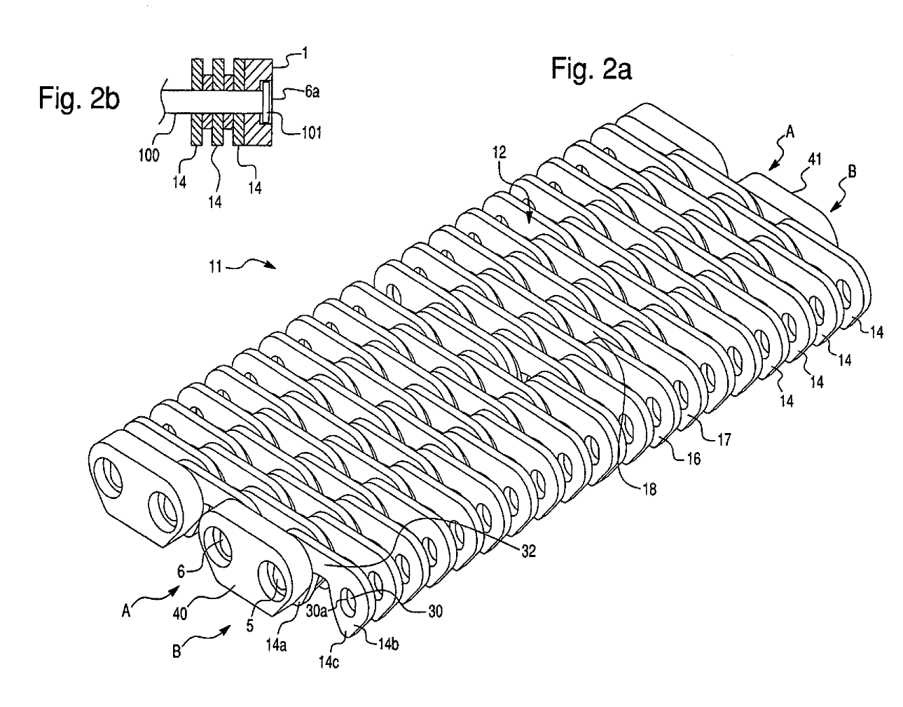

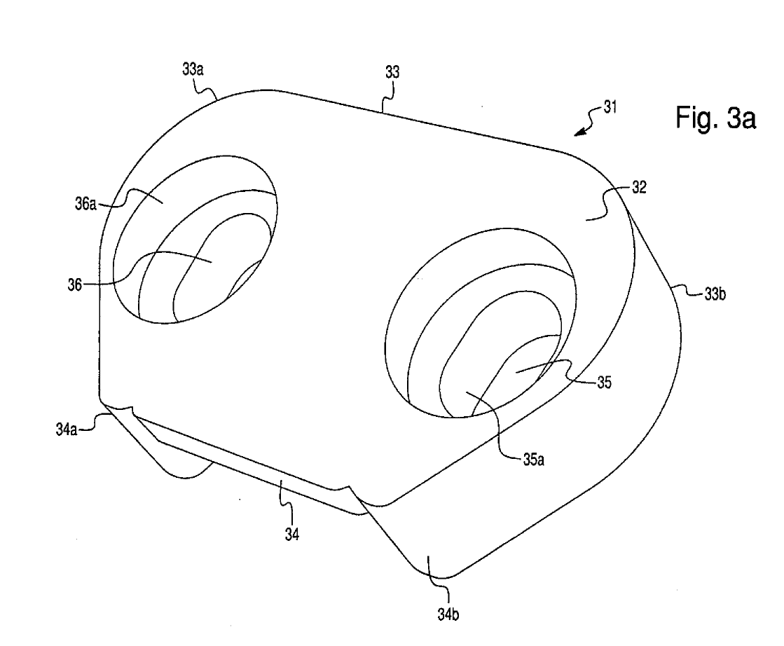

FIG. 2a illustrates in partial view an embodiment of the multi-link conveyor chain of the invention designated generally by reference numeral 11. For the sake of clarity, the elongate pins are omitted from FIG. 2a.

The multi-link conveyor chain 11 provides a flat surface 12 upon which may be carried articles such as glass bottles to a processing station. The multi-link conveyor chain 11 comprises a series of elongate pins of elliptical section upon which are mounted a number of link plates 14. FIG. 2b is a partial side view of the multi-link conveyor 11 of FIG. 2a which shows a representative elongate pin 100 passing through link plates 14. Each pair of consecutive link plates (16 and 17 for example) is spaced apart along an elongate pin. Link plates (16, 17 and 18 for example) are mounted consecutively in a staggered fashion along a first, second and third elongate pin.

Each of the plurality of link plates 14 has twin links 14a, 14b having a substantially teardrop profile which extends into a flat-edged, sprocket engaging tooth 14c. Each link 14a, 14b is connected by a connecting portion 32. A non-circular aperture 30 in link 14a non-identically matches the elliptical section of an elongate pin. The aperture 30 is substantially elliptical with an enlarged side portion 30a extending inwardly towards connecting portion 32.

To assemble the multi-link conveyor chain 11 of FIG. 2a, the first end of each of a pair of elongate pins of elliptical section is fitted with a first flat pin head 101 by spin riveting. The second end of each of the pair of elongate pins is inserted into the first and second elliptical apertures 5 and 6 (respectively at positions A and B) of a first enclosure member 41 and through the plurality of link plates to a position in which the first flat pin heads are seated in the counterbores 5a and 6a respectively. The second end of each of the pair of elongate pins extends beyond the outermost link plate and is inserted into the first and second elliptical apertures 5 and 6 respectively of a second enclosure member 40. Each enclosure member 40 and 41 is as hereinbefore described with reference to FIG. 1 (and the numbering where appropriate is retained). The second end of each of the pair of elongate pins is secured with a flat pin head seated in the counterbore 5a and 6a. This may be produced by eccentrically spin riveting a piece of carbide as hereinbefore described to the second end of the elongate pin within the counterbore. In this manner, the ends of each elongate pin may be protected using first and second enclosure members.

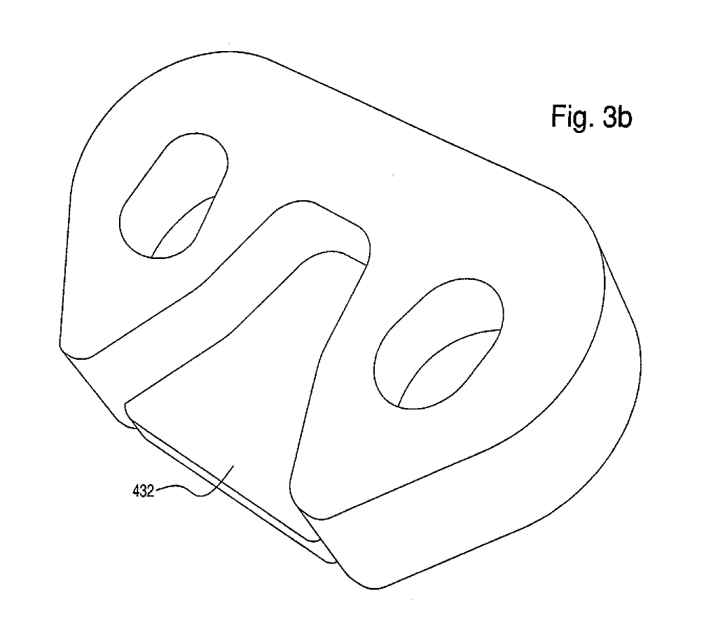

FIGS. 3a and 3b illustrate a second embodiment of the enclosure member of the invention designated generally by reference numeral 31. The enclosure member 31 is used in side guide chains. The enclosure member 31 comprises a trapezoidal main body 32 having a long side 33 parallel to a closed short side 34. The corners 33a and 33b of the long side 33 are rounded off (and to a lesser extent so are the corners 34a and 34b of the short side 34). The rear face of the main body 32 is partially recessed with a substantially U-shaped recess 432. The main body 32 defines a first non-circular aperture 35 and a second non-circular aperture 36, each of which are elliptical and provided with a cylindrical counterbore 35a and 36a respectively. The counterbores 35a and 36a are non-tapered.

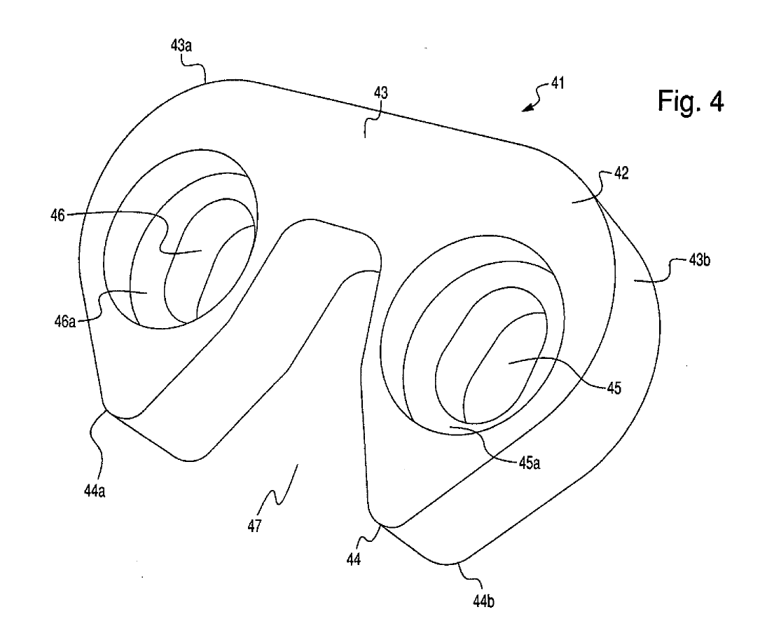

FIG. 4 illustrates a third embodiment of the enclosure member of the invention designated generally by reference numeral 41. The enclosure member 41 is used in center guide chains. The enclosure member 41 comprises a trapezoidal main body 42 having a long side 43 parallel to an open short side 44. The open short side is defined by a deep U-shaped cut-away portion 47. The corners 43a and 43b of the long side 43 are rounded off (and to a lesser extent so are the corners 44a and 44b of the short side 44). The main body 42 defines a first non-circular aperture 45 and a second non-circular aperture 46, each of which are elliptical and provided with a cylindrical counterbore 45a and 46a respectively. The counterbores 45a and 46a are non-tapered.

What is claimed is:

1. A multi-link conveyor chain adapted to provide a substantially flat horizontal surface drivable between a first processing station and a second processing station by engagement with a drive sprocket, said multi-link conveyor chain comprising:
a plurality of elongate pins spaced apart in substantially parallel relationship including a first elongate pin adjacent to a second elongate pin, the first elongate pin having a non-circular, substantially elliptical section and a first end extending beyond a first edge of the substantially flat horizontal surface and a second end extending beyond a second edge of the substantially flat horizontal surface, the second elongate pin having a non-circular, substantially elliptical section and a first end extending beyond the first edge of the substantially flat horizontal surface and a second end extending beyond the second edge of the substantially flat horizontal surface;
a plurality of link plates mounted on adjacent elongate pins having a first link connected to a second link by a connecting portion, each of the first and second links having a main body and a circumferentially dependent sprocket engaging member, said main body defining a non-circular, substantially elliptical aperture whose shape essentially matches the non-circular, substantially elliptical section of an elongate pin of said plurality of elongate pins;
a first enclosure member positioned at the first edge of the substantially flat horizontal surface yet being discrete and separable from the plurality of link plates and the elongate pins, comprising a first main body having a first front face, a first rear face opposite to the first front face, and first sides opposite to one another and extending between the first front and rear faces, wherein either the first rear face has a first recess extending from one of the first sides or one of the first sides is open;
the first main body defining a first non-circular aperture and a second non-circular aperture each extending between the first front face and the first rear face, the first front face having first and second non-tapered counterbores respectively formed at the first and second non-circular apertures, wherein the shape of the first and second non-circular apertures essentially matches the non-circular, substantially elliptical sections of the first elongate pin and the second elongate pin respectively and the depth of the first and second non-circular apertures is sufficient to enclose the first end of the first elongate pin and the first end of the second elongate pin respectively;
a second enclosure member positioned at the second edge of the substantially flat horizontal surface yet being discrete and separable from the plurality of link plates and the elongate pins, comprising a second main body having a second front face, a second rear face opposite to the second front face, and second sides opposite to one another and extending between the second front and rear faces, wherein either the second rear face has a second recess extending from one of the second sides or one of the second sides is open;
the second main body defining a third non-circular aperture and a fourth non-circular aperture each extending between the second front face and the second rear face, the second front surface having third and fourth non-tapered counterbores respectively formed at the third and fourth non-circular apertures, wherein the shape of the third and fourth non-circular apertures essentially matches the non-circular, substantially elliptical sections of the first elongate pin and the second elongate pin respectively and the depth of the third and fourth non-circular apertures is sufficient to enclose the second end of the first elongate pin and the second end of the second elongate pin respectively;
a first flat pin head secured to and retaining the first end of the first elongate pin and seated in the first non-tapered counterbore of the first non-circular aperture;
a second flat pin head secured to and retaining the first end of the second elongate pin and seated in the second non-tapered counterbore of the second non-circular aperture;
a third flat pin head secured to and retaining the second end of the first elongate pin and seated in the third non-tapered counterbore of the third non-circular aperture; and
a fourth flat pin head secured to and retaining the second end of the second elongate pin and seated in the fourth non-tapered counterbore of the fourth non-circular aperture.

2. A multi-link conveyor chain as claimed in claim 1 wherein the first, second, third and fourth flat pin heads are fully encapsulated within the non-tapered counterbores.

3. A multi-link conveyor chain as claimed in claim 1 wherein the non-tapered counterbores are flat recessed.

4. A multi-link conveyor chain as claimed in claim 1 wherein the first sides include a first long side and a first short side, wherein the second sides include a second long side and a second short side.

5. A multi-link conveyor chain as claimed in claim 1 wherein each of the first and second links of the link plate has a substantially teardrop profile.

6. A multi-link conveyor chain as claimed in claim 1, wherein:
the elongate pins comprise first, second, and third elongate pins spaced apart in substantially parallel and adjacent relationship to one another, the second elongate pin being interposed between the first and third elongate pins; and
the discrete link plates are arranged to define a plurality of rows extending perpendicular to a direction of travel of the multi-link conveyor chain, the plurality of rows including a first row of first discrete link plates of said plurality of discrete link plates and a second row of second discrete link plates of said plurality of discrete link plates, the first discrete link plates alternating in a staggered relationship with the second discrete link plates, the apertures of the first and second links of the first discrete link plates of the first row receiving the first and second elongate pins, respectively, the apertures of the first and second links of the second discrete link plates of the second row receiving the second and third elongate pins, respectively, the discrete link plates collectively establishing the substantially flat horizontal surface.

7. A multi-link conveyor chain adapted to provide a substantially flat horizontal surface drivable between a first processing station and a second processing station by engagement with a drive sprocket, said multi-link conveyor chain comprising:
a plurality of elongate pins spaced apart in substantially parallel relationship including a first elongate pin adjacent to a second elongate pin, the first elongate pin having a non-circular, substantially elliptical section and a first end extending beyond a first edge of the substantially flat horizontal surface and a second end extending beyond a second edge of the substantially flat horizontal surface, the second elongate pin having a non-circular, substantially elliptical section and a first end extending beyond the first edge of the substantially flat horizontal surface and a second end extending beyond the second edge of the substantially flat horizontal surface;
a plurality of link plates mounted on adjacent elongate pins having a first link connected to a second link by a connecting portion, each of the first and second links having a main body and a circumferentially dependent sprocket engaging member, said main body defining a non-circular, substantially elliptical aperture whose shape essentially matches the non-circular, substantially elliptical section of an elongate pin of said plurality of elongate pins;
a first enclosure member positioned at the first edge of the substantially flat horizontal surface yet being discrete and separable from the plurality of link plates and the elongate pins, comprising a first main body having a first front face, a recessed first rear face opposite to the first front face, and closed first sides opposite to one another and extending between the first front and rear faces, the recessed first rear face having a first recess extending from one of the closed first sides;
the first main body defining a first non-circular aperture and a second non-circular aperture each extending between the first front face and the first rear face, the first front face having first and second non-tapered counterbores respectively formed at the first and second non-circular apertures, wherein the shape of the first and second non-circular apertures essentially matches the non-circular, substantially elliptical sections of the first elongate pin and the second elongate pin respectively and the depth of the first and second non-circular apertures is sufficient to enclose the first end of the first elongate pin and the first end of the second elongate pin respectively;
a second enclosure member positioned at the second edge of the substantially flat horizontal surface yet being discrete and separable from the plurality of link plates and the elongate pins, comprising a second main body having a second front face, a recessed second rear face opposite to the second front face, and closed second sides opposite to one another and extending between the second front and rear faces, the recessed second rear face having a second recess extending from one of the closed second sides;
the second main body defining a third non-circular aperture and a fourth non-circular aperture each extending between the second front face and the second rear face, the second front surface having third and fourth non-tapered counterbores respectively formed at the third and fourth non-circular apertures, wherein the shape of the third and fourth non-circular apertures essentially matches the non-circular, substantially elliptical sections of the first elongate pin and the second elongate pin respectively and the depth of the third and fourth non-circular apertures is sufficient to enclose the second end of the first elongate pin and the second end of the second elongate pin respectively;
a first flat pin head secured to and retaining the first end of the first elongate pin and seated in the first non-tapered counterbore of the first non-circular aperture;
a second flat pin head secured to and retaining the first end of the second elongate pin and seated in the second non-tapered counterbore of the second non-circular aperture;
a third flat pin head secured to and retaining the second end of the first elongate pin and seated in the third non-tapered counterbore of the third non-circular aperture; and
a fourth flat pin head secured to and retaining the second end of the second elongate pin and seated in the fourth non-tapered counterbore of the fourth non-circular aperture.

8. A multi-link conveyor chain as claimed in claim 7 wherein the first, second, third and fourth flat pin heads are fully encapsulated within the non-tapered counterbores.

9. A multi-link conveyor chain as claimed in claim 7 wherein the non-tapered counterbores are flat recessed.

10. A multi-link conveyor chain as claimed in claim 7 wherein the closed first sides include a closed first long side and a closed first short side, wherein the closed second sides include a closed second long side and a closed second short side, and wherein the first and second recesses extend from the closed first and second short sides, respectively.

11. A multi-link conveyor chain as claimed in claim 7 wherein each of the first and second links of the link plate has a substantially teardrop profile.

12. A multi-link conveyor chain as claimed in claim 7 wherein the enclosure members are adapted for use in side guide conveyor chains.

13. A multi-link conveyor chain as claimed in claim 7, wherein:
the elongate pins comprise first, second, and third elongate pins spaced apart in substantially parallel and adjacent relationship to one another, the second elongate pin being interposed between the first and third elongate pins; and
the discrete link plates are arranged to define a plurality of rows extending perpendicular to a direction of travel of the multi-link conveyor chain, the plurality of rows including a first row of first discrete link plates of said plurality of discrete link plates and a second row of second discrete link plates of said plurality of discrete link plates, the first discrete link plates alternating in a staggered relationship with the second discrete link plates, the apertures of the first and second links of the first discrete link plates of the first row receiving the first and second elongate pins, respectively, the apertures of the first and second links of the second discrete link plates of the second row receiving the second and third elongate pins, respectively, the discrete link plates collectively establishing the substantially flat horizontal surface.

14. A multi-link conveyor chain adapted to provide a substantially flat horizontal surface drivable between a first processing station and a second processing station by engagement with a drive sprocket, said multi-link conveyor chain comprising:
a plurality of elongate pins spaced apart in substantially parallel relationship including a first elongate pin adjacent to a second elongate pin, the first elongate pin having a non-circular, substantially elliptical section and a first end extending beyond a first edge of the substantially flat horizontal surface and a second end extending beyond a second edge of the substantially flat horizontal surface, the second elongate pin having a non-circular, substantially elliptical section and a first end extending beyond the first edge of the substantially flat horizontal surface and a second end extending beyond the second edge of the substantially flat horizontal surface;
a plurality of link plates mounted on adjacent elongate pins having a first link connected to a second link by a connecting portion, each of the first and second links having a main body and a circumferentially dependent sprocket engaging member, said main body defining a non-circular, substantially elliptical aperture whose shape essentially matches the non-circular, substantially elliptical section of an elongate pin of said plurality of elongate pins;
a first enclosure member positioned at the first edge of the substantially flat horizontal surface yet being discrete and separable from the plurality of link plates and the elongate pins, comprising a first main body having a first front face, a first rear face opposite to the first front face, and first sides opposite to one another and extending between the first front face and the first rear face, one of the first sides being open,
the first main body defining a first non-circular aperture and a second non-circular aperture each extending between the first front face and the first rear face, the first front face having first and second non-tapered counterbores respectively formed at the first and second non-circular apertures, wherein the shape of the first and second non-circular apertures essentially matches the non-circular, substantially elliptical sections of the first elongate pin and the second elongate pin respectively and the depth of the first and second non-circular apertures is sufficient to enclose the first end of the first elongate pin and the first end of the second elongate pin respectively;
a second enclosure member positioned at the second edge of the substantially flat horizontal surface yet being discrete and separable from the plurality of link plates and the elongate pins, comprising a second main body having a second front face, a second rear face opposite to the second front face, and second sides opposite to one another and extending between the second front face and the second rear face, one of the second sides being open,
the second main body defining a third non-circular aperture and a fourth non-circular aperture each extending between the second front face and the second rear face, the second front surface having third and fourth non-tapered counterbores respectively formed at the third and fourth non-circular apertures, wherein the shape of the third and fourth non-circular apertures essentially matches the non-circular, substantially elliptical sections of the first elongate pin and the second elongate pin respectively and the depth of the third and fourth non-circular apertures is sufficient to enclose the second end of the first elongate pin and the second end of the second elongate pin respectively;
a first flat pin head secured to and retaining the first end of the first elongate pin and seated in the first non-tapered counterbore of the first non-circular aperture;
a second flat pin head secured to and retaining the first end of the second elongate pin and seated in the second non-tapered counterbore of the second non-circular aperture;
a third flat pin head secured to and retaining the second end of the first elongate pin and seated in the third non-tapered counterbore of the third non-circular aperture; and
a fourth flat pin head secured to and retaining the second end of the second elongate pin and seated in the fourth non-tapered counterbore of the fourth non-circular aperture.

15. A multi-link conveyor chain as claimed in claim 14 wherein the first, second, third and fourth flat pin heads are fully encapsulated within the non-tapered counterbores.

16. A multi-link conveyor chain as claimed in claim 14 wherein each of the first and second links of the link plate has a substantially teardrop profile.

17. A multi-link conveyor chain as claimed in claim 14 wherein the first sides include a first long side and a first short side, wherein the second sides include a second long side and a second short side, and wherein the first and second short sides are open.

18. A multi-link conveyor chain as claimed in claim 14 wherein the main bodies each possess a twin flat-edged, substantially teardrop profile.

19. A multi-link conveyor chain as claimed in claim 14 wherein the enclosure members are adapted for use in center guide conveyor chains.

20. A multi-link conveyor chain as claimed in claim 14, wherein:
the elongate pins comprise first, second, and third elongate pins spaced apart in substantially parallel and adjacent relationship to one another, the second elongate pin being interposed between the first and third elongate pins; and
the discrete link plates are arranged to define a plurality of rows extending perpendicular to a direction of travel of the multi-link conveyor chain, the plurality of rows including a first row of first discrete link plates of said plurality of discrete link plates and a second row of second discrete link plates of said plurality of discrete link plates, the first discrete link plates alternating in a staggered relationship with the second discrete link plates, the apertures of the first and second links of the first discrete link plates of the first row receiving the first and second elongate pins, respectively, the apertures of the first and second links of the second discrete link plates of the second row receiving the second and third elongate pins, respectively, the discrete link plates collectively establishing the substantially flat horizontal surface.
